(19) United States
(12) Patent Application Publication
(10) Pub. No.: US 2010/0178522 A1
(43) Pub. Date: Jul. 15, 2010

(54) HANDPIECE FOR DENTAL OR SURGICAL USE

(75) Inventor: Vincent Mosimann, La Neuveville (CH)

Correspondence Address: GRIFFIN & SZIPL, PC, SUITE PH-1, 2300 NINTH STREET, SOUTH, ARLINGTON, VA, 22204, US

(73) Assignee: BIEN-AIR HOLDING S.A., Bienne 6 (CH)

(21) Appl. No.: 12/531,611

(22) PCT Filed: Feb. 19, 2008
(86) PCT No.: PCT/CH08/00069

§ 371 Date: Feb. 22, 2010

(30) Foreign Application Priority Data
Mar. 16, 2007 (CH) 450/07

(51) Int. Cl. B32B 15/04

(52) U.S. Cl. 428/457

(57) ABSTRACT

The invention relates to a handheld part for dental or surgical use that comprises static components, i.e. head and body, and dynamic components, i.e. dented wheels, drivers, turbines, characterized in that some at least of the static and/or dynamic components are made of a metallic alloy that solidifies at least partially in an amorphous phase in the volume.

This is a National Phase Application in the United States of International Patent Application PCT/CH2008/000069 filed Feb. 19, 2008, which claims priority on Swiss Patent Application No. 00450/07 of Mar. 16, 2007. The entire disclosures of the above patent applications are hereby incorporated by reference.

### FIELD OF THE INVENTION

The present invention concerns a hand piece for dental or surgical use. More specifically, the present invention concerns an instrument of this type for dental or surgical use, whose body is made of an easily machinable light material.

### BACKGROUND OF THE INVENTION

There are two main families of hand held instruments for dental or surgical use. The first of these families includes what are known as turbines, namely instruments in which the tool, for example a bur, is coupled with a motor, driven by pressurized air. The motor can rotate at several hundred thousand revolutions per minute with an air pressure that is typically of the order of magnitude of 2.5 to 3 bars. The turbine includes a body that enables the practitioner to hold the instrument in his hand. The body is conventionally connected to an electric power and fluid (air, water) supply unit, via a connector and flexible hose.

The second family of instruments for dental or surgical use includes what are known as handpieces and contra-angle handpieces. Handpieces and contra-angles differ essentially in that the body of a handpiece is approximately straight, whereas the body of a contra-angle handpiece forms an angle at one point on the length thereof. Otherwise, these two types of instrument are very similar. A motor, secured to the handpiece or contra-angle handpiece and capable of rotating at several tens of thousands of revolutions per minute, is connected via a fixed or rotating connector hose to the supply unit.

For reasons of convenience, instruments for dental or surgical use such as those described above, will be designated by the generic expression “handpiece”, in the knowledge that this expressions covers both actual handpieces and turbines and contra-angle handpieces.

Handpieces are essentially made up of a body, which allows them to be held in the hand, and a head that carries the tool. These elements are conventionally manufactured from a brass or stainless steel bar. They have extremely complex external and internal shapes, which are long and expensive to machine (cutting, piercing, threading, stamping, etc.) and require sophisticated machine tools that may include up to eight different machining axes. Moreover, however sophisticated the machining apparatus used, there is always a limit as to the shape that can be given to these elements.

It should also be noted that the materials used—brass or stainless steel—have advantages but also drawbacks. Brass, for example, is a material prized by designers because it is easy to machine. However, brass has the drawback of oxidising easily and thus has to undergo surface treatments with depositions of inoxidizable layers. These relatively fragile layers tend to wear and scratch easily, allowing the subjacent brass layer to appear, which gives practitioners the feeling that the instrument is of mediocre quality. Moreover, some of the layers contain nickel, to which the practitioner may develop an allergy when the layers are stripped bare.

Conversely, stainless steel is, by definition, a material that resists corrosion well and thus does not require any specific treatment in this regard. Further, stainless steel is lighter than brass and can thus be used to make handpieces that are lighter in the practitioner's hand, thereby reducing the fatigue that he may feel after several hours work. However, stainless steel has the drawback of being difficult to machine.

In order to overcome these problems, some handpiece components are already made by injection of plastic materials (elements for connecting handpieces to the power and control unit, insulating elements for electric connectors, turbine wings, etc.). Some of the plastic materials used are biocompatible, allowing manufacture of components that will come into contact with the practitioner or patient. Injection of plastic materials also removes almost all constraints as regards the shape of the elements being made. It also means that these elements can be made with a high level of precision and delivered almost ready for use after they have been removed from the mould. However, the use of plastic materials has not become widespread as these materials raise problems of mechanical performance over time and are not well viewed by practitioners.

There was, therefore, a need in the state of the art for a material that combined the advantages of plastic materials (lightness, freedom as regards shape, precision, repeatability and rapidity of injection) and metallic materials (longevity, mechanical performance).

### SUMMARY OF THE INVENTION

It is an object of the present invention to answer this expectation by providing a handpiece for dental or surgical use that includes fixed components and mobile components, characterized in that at least some of these fixed and/or mobile components are made of a metal alloy, which bulk solidifies, at least partially, in an amorphous phase.

### DETAILED DESCRIPTION OF THE PREFERRED EMBODIMENTS

The fixed components of a handpiece include, in particular, the head and handle of such handpieces. The mobile components include, amongst other things, the toothed wheels, drivers for transmitting the drive torque to the tools and some of the electric motor components.

The main obstacle which, until now, conflicted with the use of such bulk amorphous metal alloys arises from the fact that it was believed that a specific production tool had to be used for such materials. The Applicant has realised that amorphous allied materials could be injected by the same machines as those usually used for injecting plastic materials. This is due to the fact that these alloys typically have a low softening and melting temperature, less than or equal to 600° C. It is not therefore necessary to make heavy outlays to purchase a new production tool. There is also great freedom as regards the shapes that can be imparted to the various components as well as a high level of manufacturing precision. This manufacturing precision is due in particular to the absence of any crystalline phase formation during cooling. There is thus much less shrinkage of injected parts since no atomic rearrangement is observed. Moreover, the components are almost ready to use after removal from the mould. All that is required are finishing steps, such as surface treatment or deposition of a decorative coating. Further, the metallic components thus obtained have excellent mechanical properties, they are corrosion resistant and between 15 and 30% lighter than stainless steel components, depending upon the composition of the alloy employed. Further, some of these alloys are biocompatible. It will also be noted that some of the amorphous metal alloys concerned here have advantageous magnetic properties, in particular low eddy current losses, making them naturally suitable for making some electric motor parts.

According to a complementary feature of the invention, the metal alloy includes at least 50% bulk amorphous phase.

According to another feature of the invention, the metal alloy is entirely bulk amorphous.

Any entirely bulk-solidifying amorphous phase metal alloy can be used within the scope of the present invention. Bulk-solidification of amorphous alloys refers to the family of amorphous alloys that can be cooled at cooling speeds as low as 500° K. per second or less, and which more or less maintain their amorphous atomic structure. In other words, from a crystallographic point of view, these bulk amorphous metal alloys have an amorphous structure in which a few mono-crystalline grains may be dispersed.

A typical example of amorphous metal alloys that bulk solidify suitably in amorphous phase is given by the Zr—Al—R, Zr—Al—Ni—Cu and Zr—Ti—Ni—Cu—Be alloys, to which yttrium can be added. More specifically, these metal alloys are described by the following molecular formulae:
ZrₓAl_{y}R_{z} with x, y<100 and z=x-y;
Zr₅₅Al₁₅ Ni₁₀ Cu₂₀)₁₀₀₋ₓ Yₓ with x comprised within 0 and 10;
Zr₆₅ Al_{7.5} Ni₁₀ Be_{22.5})₁₀₀₋ₓ Yₓ with x comprised within 0 and 6;
Zr₄₁ Ti₁₄ Cu_{12.5} Ni₁₀ Be_{22.5})₉₈ Y₂ and;
Zr₃₄ Ti₁₅ Cu₁₂ Ni₁₁ Be₂₈ Y₂.

It goes without saying that the present invention is not limited to the embodiments that have just been described and that those skilled in the art may envisage various simple alterations and variants without departing from the scope of the present invention as defined by the claims annexed to this Patent Application. It will be noted, in particular, that one of the features specific to these amorphous alloys lies in the fact that they pass from the solid phase to the liquid phase by passing through a distinct deformable plastic phase, unlike conventional metals, which pass directly from the solid phase to the liquid phase. This feature makes it possible to use the implementing means usually employed for other materials.

1-9. (canceled)

10. A handpiece for dental or surgical use including static components and dynamic components, wherein at least some of said static and/or dynamic components are made of a metal alloy that bulk solidifies in an amorphous phase.

11. The handpiece according to claim 10, wherein the metal alloy includes at least 50% bulk amorphous phase.

12. The handpiece according to claim 11, wherein the metal alloy is entirely bulk amorphous.

13. The handpiece according to claim 10, wherein the amorphous metal alloy has a softening and melting temperature lower than or equal to 600° C.

14. The handpiece according to claim 11, wherein the amorphous metal alloy has a softening and melting temperature lower than or equal to 600° C.

15. The handpiece according to claim 12, wherein the amorphous metal alloy has a softening and melting temperature lower than or equal to 600° C.

16. The handpiece according to claim 10, wherein, between the solid phase and the liquid phase, the amorphous metal alloy has a phase in which it is plastically deformable.

17. The handpiece according to claim 11, wherein, between the solid phase and the liquid phase, the amorphous metal alloy has a phase in which it is plastically deformable.

18. The handpiece according to claim 12, wherein, between the solid phase and the liquid phase, the amorphous metal alloy has a phase in which it is plastically deformable.

19. The handpiece according to claim 13, wherein, between the solid phase and the liquid phase, the amorphous metal alloy has a phase in which it is plastically deformable.

20. The handpiece according to claim 14, wherein, between the solid phase and the liquid phase, the amorphous metal alloy has a phase in which it is plastically deformable.

21. The handpiece according to claim 15, wherein, between the solid phase and the liquid phase, the amorphous metal alloy has a phase in which it is plastically deformable.

22. The handpiece according to claim 10, wherein the amorphous metal alloy is biocompatible.

23. The handpiece according to claim 10, wherein the amorphous metal alloy is an alloy of Zr—Al—R, Zr—Al—Ni—Cu or Zr—Ti—Ni—Cu—Be.

24. The handpiece according to claim 11, wherein the amorphous metal alloy is an alloy of Zr—Al—R, Zr—Al—Ni—Cu or Zr—Ti—Ni—Cu—Be.

25. The handpiece according to claim 12, wherein the amorphous metal alloy is an alloy of Zr—Al—R, Zr—Al—Ni—Cu or Zr—Ti—Ni—Cu—Be.

26. The handpiece according to claim 13, wherein the amorphous metal alloy is an alloy of Zr—Al—R, Zr—Al—Ni—Cu or Zr—Ti—Ni—Cu—Be.

27. The handpiece according to claim 23, wherein the amorphous metal alloy of Zr—Al—R, Zr—Al—Ni—Cu or Zr—Ti—Ni—Cu—Be also includes yttrium.

28. The handpiece according to claim 24, wherein the amorphous metal alloy of Zr—Al—R, Zr—Al—Ni—Cu or Zr—Ti—Ni—Cu—Be also includes yttrium.

29. The handpiece according to claim 25, wherein the amorphous metal alloy of Zr—Al—R, Zr—Al—Ni—Cu or Zr—Ti—Ni—Cu—Be also includes yttrium.

30. The handpiece according to claim 26, wherein the amorphous metal alloy of Zr—Al—R, Zr—Al—Ni—Cu or Zr—Ti—Ni—Cu—Be also includes yttrium.

31. The handpiece according to claim 27, wherein the amorphous metal alloy is described by any of the following molecular formulae:
ZrₓAl_{y}R_{z} with x, y<100 and z=x-y;
Zr₅₅ Al₁₅Ni₁₀ Cu₂₀)₁₀₀₋ₓ Yₓ with x comprised within 0 and 10;
Zr₆₅ Al_{7.5} Ni₁₀ Be_{22.5})₁₀₀₋ₓ Yₓ with x comprised within 0 and 6;
Zr₄₁ Ti₁₄ Cu_{12.5} Ni₁₀ Be_{22.5})₉₈ Y₂ and;
Zr₃₄ Ti₁₅ Cu₁₂ Ni₁₁ Be₂₈ Y₂.

32. The handpiece according to claim 28, wherein the amorphous metal alloy is described by any of the following molecular formulae:
ZrₓAl_{y}R_{z} with x, y<100 and z=x-y;
Zr₅₅ Al₁₅ Ni₁₀ Cu₂₀)₁₀₀₋ₓ Yₓ with x comprised within 0 and 10;
Zr₆₅ Al_{7.5} Ni₁₀ Be_{22.5})₁₀₀₋ₓ Yₓ with x comprised within 0 and 6;
Zr₄₁ Ti₁₄ Cu_{12.5} Ni₁₀ Be_{22.5})₉₈ Y₂ and;
Zr₃₄ Ti₁₅ Cu₁₂ Ni₁₁ Be₂₈ Y₂.

33. The handpiece according to claim 29, wherein the amorphous metal alloy is described by any of the following molecular formulae:
ZrₓAl_{y}R_{z} with x, y<100 and z=x-y;
Zr₅₅ Al₁₅ Ni₁₀ Cu₂₀)₁₀₀₋ₓ Yₓ with x comprised within 0 and 10;
Zr₆₅ Al_{7.5} Ni₁₀ Be_{22.5})₁₀₀₋ₓ Yₓ with x comprised within 0 and 6;
Zr₄₁ Ti₁₄ Cu_{12.5} Ni₁₀ Be_{22.5})₉₈ Y₂ and;
Zr₃₄ Ti₁₅ Cu₁₂ Ni₁₁ Be₂₈ Y₂.

34. The handpiece according to claim 30, wherein the amorphous metal alloy is described by any of the following molecular formulae:
ZrₓAl_{y}R_{z} with x, y<100 and z=x-y;
Zr₅₅ Al₁₅ Ni₁₀ Cu₂₀)₁₀₀₋ₓ Yₓ with x comprised within 0 and 10;
Zr₆₅ Al_{7.5} Ni₁₀ Be_{22.5})₁₀₀₋ₓ Yₓ with x comprised within 0 and 6;
Zr₄₁ Ti₁₄ Cu_{12.5} Ni₁₀ Be_{22.5})₉₈ Y₂ and;
Zr₃₄ Ti₁₅ Cu₁₂ Ni₁₁ Be₂₈ Y₂.
